(19) United States
(12) Patent Application Publication
(10) Pub. No.: US 2004/0098346 A1
(43) Pub. Date: May 20, 2004

(54) Digital licenses including patterns

(75) Inventors: Bob Atkinson, Woodinville, WA (US); John DeTreville, Seattle, WA (US); Brian A. LaMacchia, Seattle, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/298,325

(22) Filed: Nov. 18, 2002

(51) Int. Cl. G06F 17/60

(52) U.S. Cl. 705/59

(57) ABSTRACT

A computer-implemented mechanism for granting rights to a resource is described. A license identifies one or more principals, resources, rights and conditions. At least one of the license elements is expressed as a pattern. The pattern encompasses a set of elements by describing common attributes. When determining whether to grant rights to a principal to access a resource, an access control module may determine whether a list of desired bindings is consistent with the pattern.

### FIELD OF THE INVENTION

The invention generally relates to the field of computer security and, more particularly, to digital licenses and related systems and methods that include elements identified by patterns.

### BACKGROUND

Trust management languages and data structures are frequently used to grant principals, such as users, rights to access digital data. Conventional trust management languages and data structures express policy using licenses. A license typically identifies the issuer, the principal, the right, the resource and any conditions on the exercise of the license. FIG. 1 illustrates a conventional mechanism for granting rights to access a group of related resources 102a-102d. Resource 102a-102d may each be a digital work in the form of an image, an audio or video file, an e-book, or the like. When a trusted issuer 104 desires to grant user 106 access to one of resources 102a-102d, trusted issuer 102 must issue a separate license for each. For example, licenses 108a-108d each correspond to one of resources 102a-102d. Each of license 108a-108d identifies a principal or user 106, a right granted, a resource and any conditions.

There are several drawbacks to the mechanism of granting rights in the manner shown in FIG. 1. Issuing a separate license for each resource 102a-102b can be both an overwhelming burden on trusted issuer 104 and on principal or user 106. Both of these problems become worse as the numbers of resources and users increase. For example, doubling the number of users and the number of resources accessible by each user will quadruple the number of licenses that must be issued.

Therefore, there is a need in the art for a trust management language and data structure that reduces the number of licenses that must be issued by a trusted issuer by identifying similarly identifiable entities using a single expression or pattern. Patterns may be used to identify resources, principals, or rights.

### SUMMARY

One or more of the above-mentioned needs in the art are satisfied by the disclosed trust management languages and data structures. One or more fields of a license are expressed as patterns. The use of a pattern reduces the number of licenses that must be issued and the associated burden on a trusted issuer and on a principal. For example, given a set of principals, instead of issuing a license to every principal that is a member of the set, issuing a single license that uses a pattern to denote the set accomplishes a similar result. The use of patterns also allows a license to relate to subsequently created resources, conditions or additional users. In one embodiment, licenses are represented in a computer language such as a computer language based on the eXtensible Markup Language (XML) and patterns are expressed using XPath.

### BRIEF DESCRIPTION OF THE DRAWINGS

Aspects of the present invention are described with respect to the accompanying figures, in which like reference numerals identify like elements, and in which:

FIG. 1 illustrates a prior art mechanism for granting rights to access a resource;

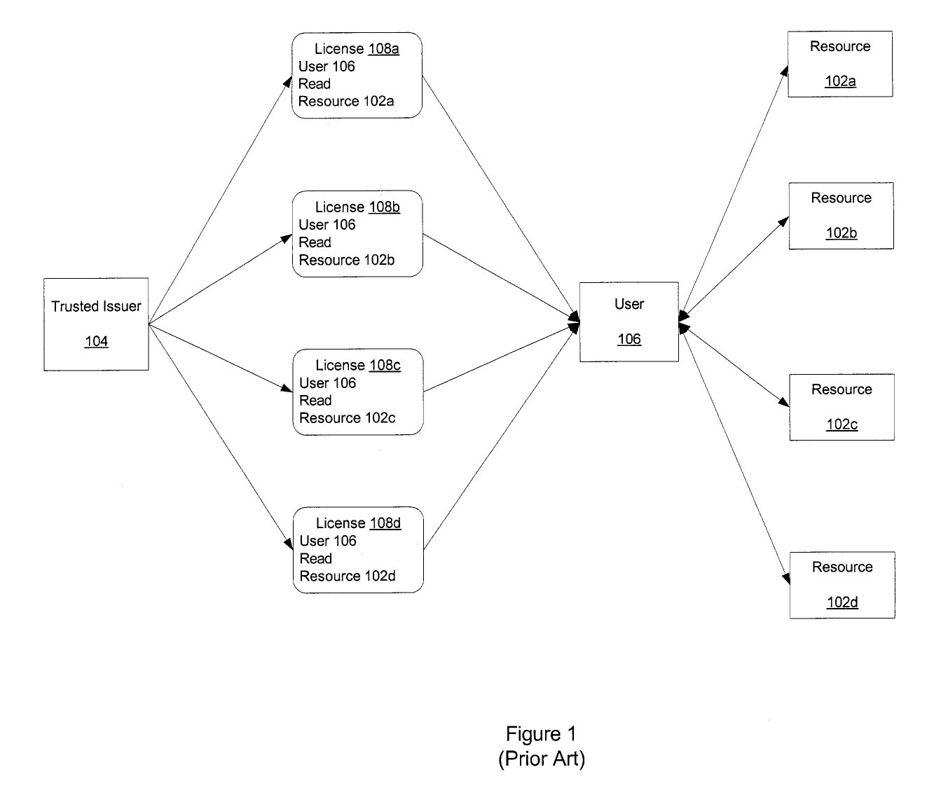

FIG. 2 shows an illustrative distributed computing system operating environment that may be used to implement aspects of the invention;

FIG. 3 illustrates a mechanism for granting a principal rights to a resource pattern, in accordance with an embodiment of the invention;

FIG. 4 illustrates a mechanism for granting a principal pattern rights to a resource, in accordance with an embodiment of the invention;

FIG. 5 illustrates a method of generating and processing licenses that include at least one field expressed as a pattern, in accordance with an embodiment of the invention; and

FIG. 6 illustrates a license formatted in accordance with an embodiment of the invention.

### DETAILED DESCRIPTION

Exemplary Operating Environment

Aspects of the present invention are suitable for use in a distributed computing system environment. In a distributed computing environment, tasks may be performed by remote computer devices that are linked through communications networks. The distributed computing environment may include client and server devices that may communicate either locally or via one or more computer networks. Embodiments of the present invention may comprise special purpose and/or general purpose computer devices that each may include standard computer hardware such as a central processing unit (CPU) or other processing means for executing computer executable instructions, computer readable media for storing executable instructions, a display or other output means for displaying or outputting information, a keyboard or other input means for inputting information, and so forth. Examples of suitable computer devices include hand-held devices, multiprocessor systems, microprocessor-based or programmable consumer electronics, networked PCs, minicomputers, mainframe computers, and the like.

The invention will be described in the general context of computer-executable instructions, such as program modules, that are executed by a processing device, including, but not limited to a personal computer. Generally, program modules include routines, programs, objects, components, data structure definitions and instances, etc., that perform particular tasks or implement particular abstract data types. Typically the functionality of the program modules may be combined or distributed as desired in various environments.

Embodiments within the scope of the present invention also include computer readable media having executable instructions. Such computer readable media can be any available media that can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

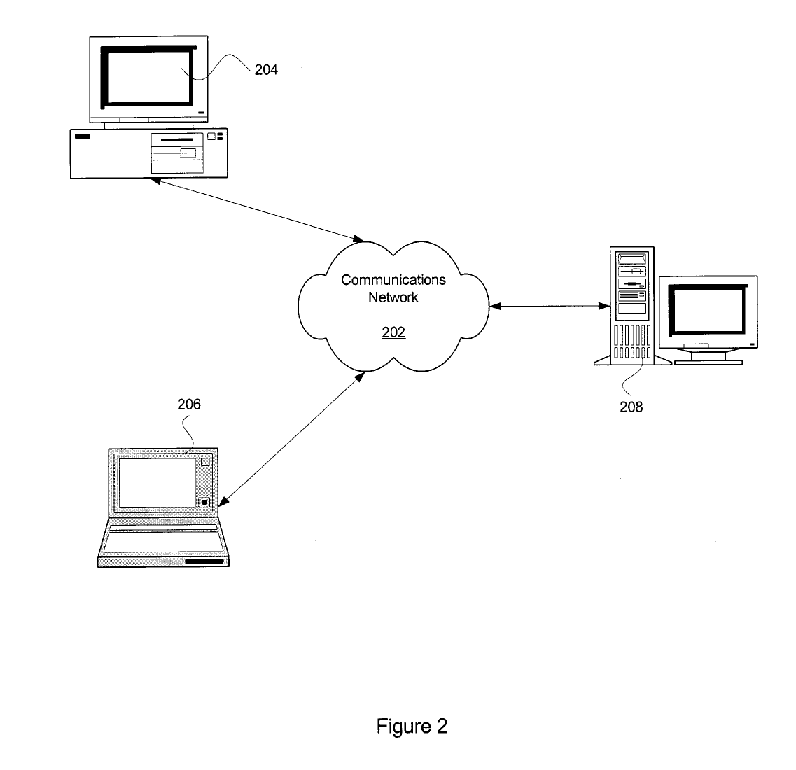

FIG. 2 illustrates an example of a suitable distributed computing system 200 operating environment in which the invention may be implemented. Distributed computing system 200 is only one example of a suitable operating environment and is not intended to suggest any limitation as to the scope of use or functionality of the invention. System 200 is shown as including a communications network 202. The specific network implementation used can be comprised of, for example, any type of local area network (LAN) and associated LAN topologies and protocols; simple point-to-point networks (such as direct modem-to-modem connection); and wide area network (WAN) implementations, including public Internets and commercial based network services such as the Microsoft Network or America Online's Network. Systems may also include more than one communication network, such as a LAN coupled to the Internet.

Computer device 204, computer device 206 and computer device 208 may be coupled to communications network 202 through communication devices. Network interfaces or adapters may be used to connect computer devices 204, 206 and 208 to a LAN. When communications network 202 includes a WAN, modems or other means for establishing communications over WANs may be utilized. Computer devices 204, 206 and 208 may communicate with one another via communication network 202 in ways that are well known in the art. The existence of any of various well-known protocols, such as TCP/IP, Ethernet, FTP, HTTP and the like, is presumed. Computer devices 204, 206 and 208 may exchange content, applications, messages and other objects via communications network 202.

Description of Illustrative Embodiments

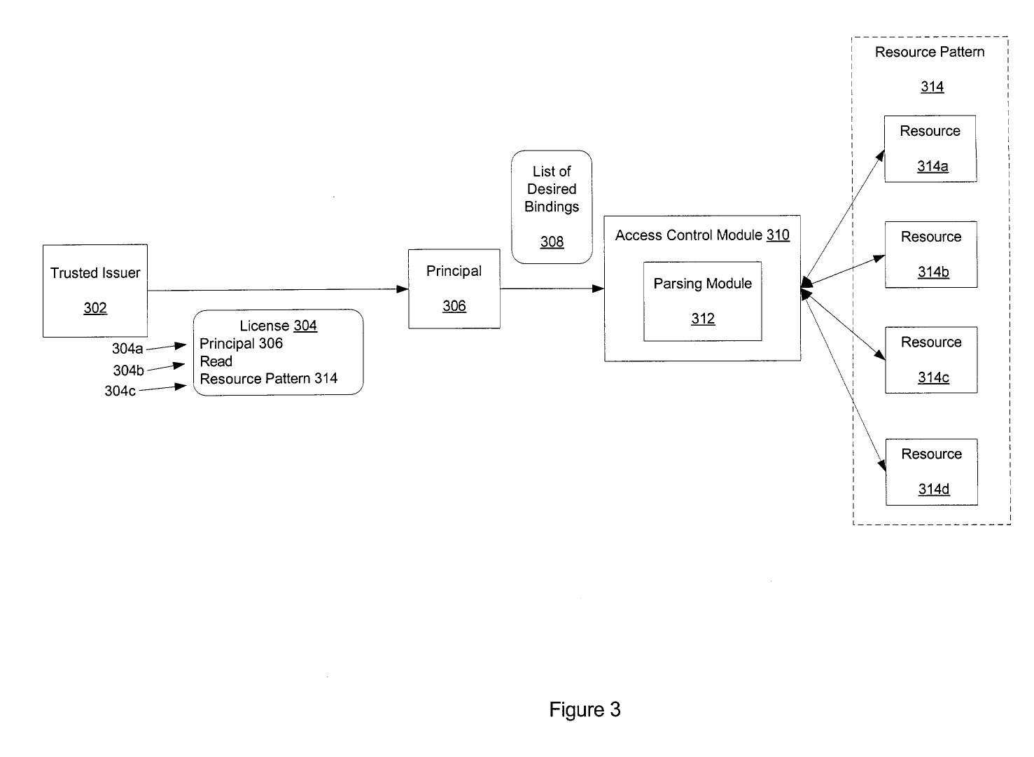

FIG. 3 illustrates a mechanism for granting rights to users to access resources in accordance with an embodiment of the invention. FIG. 3 shows an embodiment of the invention in which the trusted issuer 302 issues a license 304 to a principal 306. License 304 includes a field 304a for identifying principal 306, a field 304b for identifying a right and a field 304c for identifying a set of resources expressed as a pattern. For instance, the pattern may be a syntactic pattern that the names of the resources must match. In one example, license 304 is created within a trust management language that is a derivation of XML, such as the extensible rights markup language (XrML).

Principal 306 may exercise right 304b included in license 304 by first transmitting license 304 and a list of desired bindings 308 to an access control module 310. Of course, list of desired bindings 308 may contain any number of elements, including one. In the embodiment shown in FIG. 3 the list of desired bindings may request that the Resource Pattern identified in field 304c be bound to some particular resource 314a-314d in order to gain access to that particular resource. Access control module 310 may be a software or hardware module, residing locally or remotely to corresponding resources 314a-314b and may be used to control access to resources 314a-314b in the manner described below. Access control module 310 may include a parsing module 312 to parse and interpret licenses. In one particular embodiment that uses licenses formatted in accordance with XrML schemas, parsing module 312 parses through XrML documents to obtain license data.

FIG. 3 shows an embodiment in which a single access control module 310 is coupled to resources 314a-314d. In alternative embodiments, one or more resources 314a-314d may be coupled to additional access control modules and/or parsing modules.

In the example shown, the list of desired bindings 308 may correspond to one of resources 314a-314d that are part of a resource pattern 314. A pattern may encompass a set of elements by describing common attributes. For example, resources 314a-314d may be individual issues of a magazine. Resource pattern 314 may define the set that includes all individual issues. Resource pattern 314 may be expressed in an XML pattern expression language. For example, the pattern may be specified with XPath. In alternative embodiments of the invention patterns may be expressed through a variety of other formal expression languages. Access control module 310 may compare the list of desired bindings 308 to the resource pattern to determine whether the access request corresponding to the list of desired bindings 308 is within the pattern.

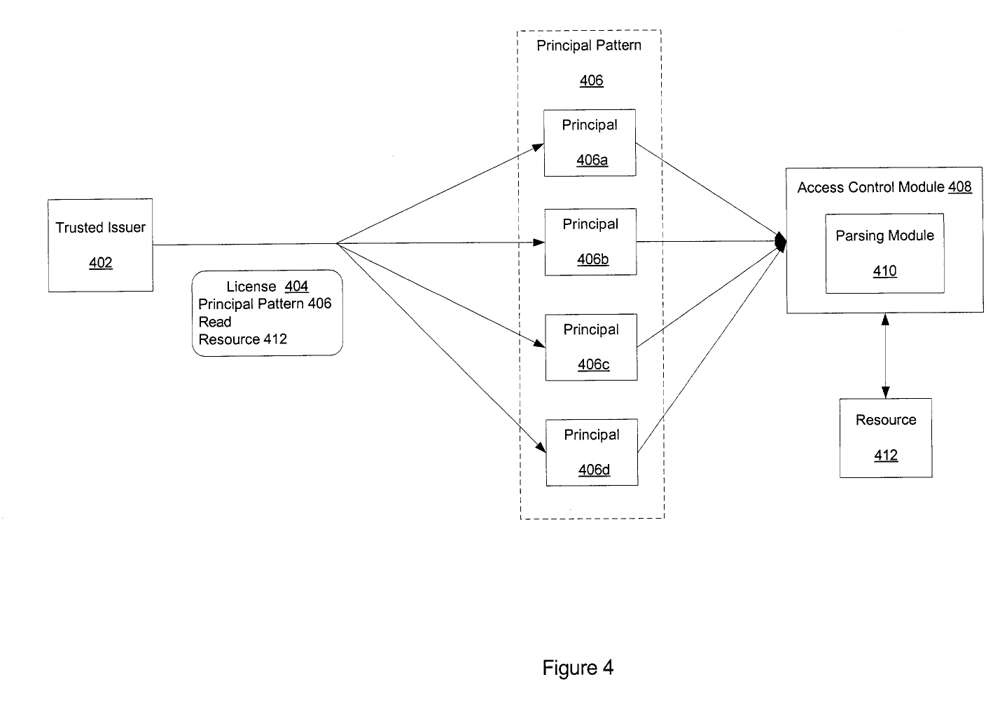

The present invention is not limited to embodiments that express only resources as patterns. In other embodiments, principals, rights, conditions, and other parts of licenses may be expressed as patterns. FIG. 4, for example, illustrates an embodiment in which a group of principals is expressed as a pattern. A trusted issuer 402 may transmit copies of a license 404 to a group of principals 406a-406d. Principals 406a-406d are members of the set of principals described by principal pattern 406. For example, principals 406a-406d may be computer systems belonging to an enterprise, email address having a common domain, members belonging to a club, a range of Internet protocol addresses or the like. Again, one embodiment of this invention uses syntactic patterns such as, but not limited to, regular expressions to specify the principals.

When one of the principals 406a-406d desires to exercise the right identified in license for 404, the principal may transmit license 404 and a list of desired bindings to an access control module 408. In an alternative embodiment of the invention, the list of desired bindings is implied by the source of the transmission, i.e., the principal is identified merely by sending a message or transmitting data. Access control module 408 may include a parsing module 410. Access control module 408 and parsing module 410 function similar to access control module 308 and parsing module 310 (shown in FIG. 3).

Licenses may also be used to give some principal the right to issue other licenses or grants. In another embodiment of the invention, these grants may themselves be specified using patterns termed as grant patterns. For example, a user may receive a license that grants the user the right to issue further licenses that are formatted in accordance with a grant pattern. The grant pattern may include a condition field that requires a license holder to pay a fee to the trusted issuer of the original license.

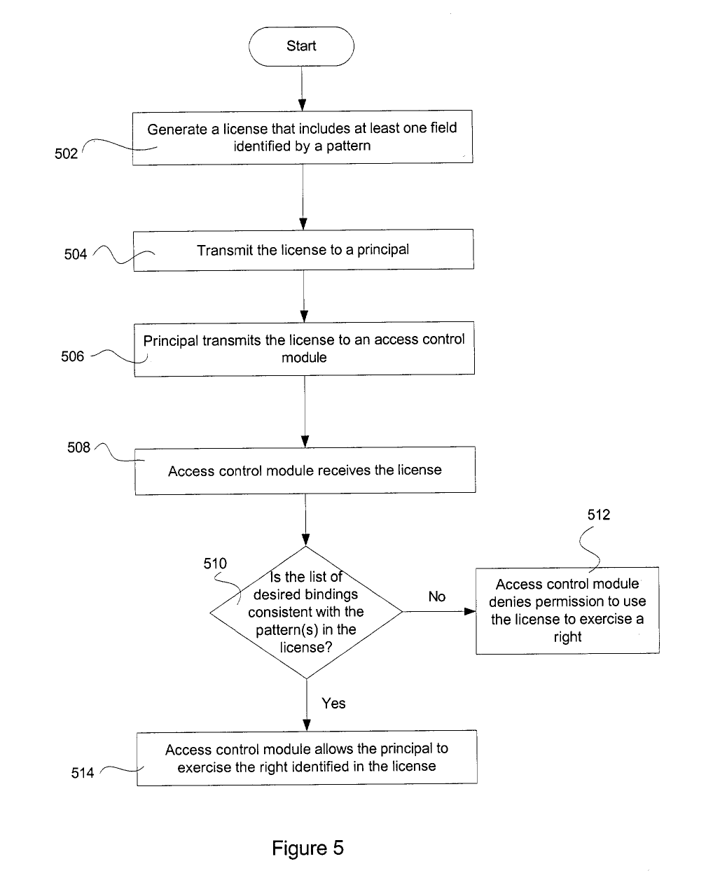

FIG. 5 illustrates a method of generating and processing licenses that include at least one field expressed as a pattern, in accordance with an embodiment of the invention. First, in step 502, a license is generated that includes at least one field identified by a pattern. In one embodiment of the invention, the license is created following the rules of a trust management language that is a derivation of XML, such as XrML. Next, the license is transmitted to a principal in step 504. In step 506, the principal transmits the license to an access control module. The principal may also transmit a list of desired bindings such as the identification of the principal, the identification of a resource, etc.

In step 508, the access control module receives the license. Next, in step 510 it is determined whether or not the list of desired bindings is consistent with the pattern or patterns described in the license. Of course, it may also be determined whether or not other license prerequisites are met, such as any conditions or prerequisite rights. When the list of desired bindings is not consistent with the pattern or patterns, in step 512 access control module denies permission to exercise the right identified in the license. When the list of desired bindings is consistent with the pattern or patterns described in the license, in step 514 the access control module allows the principal to exercise the right identified in the license.

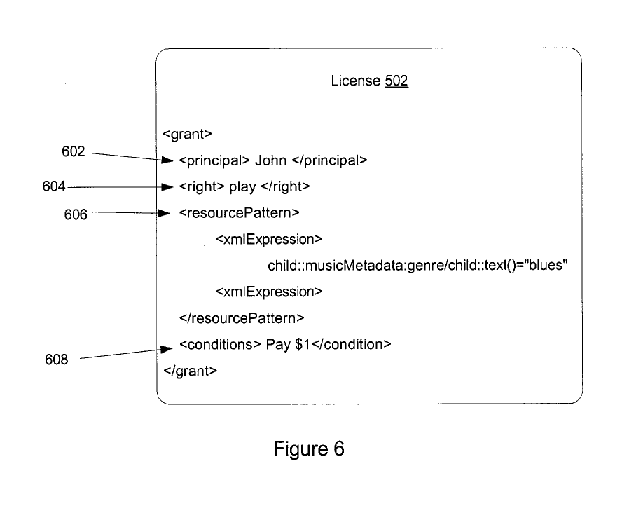

FIG. 6 illustrates a license formatted in accordance with an embodiment of the invention. As stated previously, licenses may be formatted with a usage rights language that is a derivation of XML, such as XrML. At least one principal may be identified in field 602. One or more rights may be identified in field 604. Field 606 may include one or more resources and field 608 may include one or more conditions. FIG. 6 shows an embodiment in which albums belonging to a “blues” genre pattern are identified in field 606. Other or additional fields may also include terms expressed as patterns.

Further, embodiments of the invention may be implemented in hardware, software, or by an application specific integrated circuit (ASIC). The firmware may be in a read-only memory and the software may reside on a medium including, but not limited to, read-only memory, random access memory, floppy disk or compact disc.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A computer-implemented method of processing a license that grants a right, the method comprising:
(a) receiving the license that includes at least one field expressed as a pattern;
(b) determining whether a list of desired bindings is consistent with the pattern; and
(c) allowing a principal to exercise the right when the list of desired bindings is consistent with the pattern.

2. The computer-implemented method of claim 1, wherein the pattern comprises criteria defining a set of principals and the list of desired bindings names a principal.

3. The computer-implemented method of claim 1, wherein the pattern comprises criteria defining a set of resources and the list of desired bindings names a resource.

4. The computer-implemented method of claim 1, wherein the pattern comprises criteria defining a right and the list of desired bindings names a right.

5. The computer-implemented method of claim 1, wherein at least two fields of the license are expressed as patterns.

6. The computer-implemented method of claim 1, wherein the list of desired bindings is created after the license is created.

7. The computer-implemented method of claim 1, wherein the license is issued by a trusted issuer and the trusted issuer does not know at the time of issuance of the license all of the individual elements that belong to a set characterized by the pattern.

8. The computer-implemented method of claim 1, wherein the pattern defines a set of Internet protocol addresses.

9. The computer-implemented method of claim 1, wherein the pattern defines a set of computer devices.

10. The computer-implemented method of claim 1, wherein the license is created within a trust management language that is a derivation of XML.

11. The computer-implemented method of claim 10, wherein the pattern is specified with an XML pattern expression language.

12. The computer-implemented method of claim 11, wherein the pattern expression language comprises XPath.

13. The computer-implemented method of claim 1, wherein the license is a data structure created with an object-oriented programming language.

14. The computer-implemented method of claim 1, wherein the right includes a right to download a digital file.

15. The computer-implemented method of claim 1, wherein the right includes a right associated with a service.

16. The computer-implemented method of claim 1, wherein the license grants rights to a set of at least two principals and the set of principals is expressed as a pattern.

17. A computer-implemented method of granting at least one principal at least one right, the method comprising: generating a license that includes at least one field expressed as a pattern.

18. The computer-implemented method of claim 17, wherein the license is issued by a trusted issuer and the trusted issuer does not know at the time of issuance of the license all of the individual elements that belong to a set characterized by the pattern.

19. The computer-implemented method of claim 17, wherein the license is created with a usage rights language that is a derivation of XML.

20. The computer-implemented method of claim 19, wherein the pattern is specified with an XML pattern expression language.

21. The computer-implemented method of claim 20, wherein the pattern expression language comprises XPath.

22. A computer-readable medium containing computer-executable instructions for causing a computer device to process a license that includes at least principal and right fields for granting at least a principal a right by performing the steps comprising:
(a) receiving the license that includes at least one of the fields expressed as a pattern;
(b) determining whether a list of desired bindings is consistent with the pattern; and
(c) allowing a particular principal to exercise a particular right to access a particular resource when the list of desired bindings is consistent with the pattern.

23. A computer-readable medium having stored thereon a license data structure, said license data structure comprising:
a first field identifying at least one principal;
a second field identifying at least one right associate with at least one resource;
a third field identifying at least one resource; and
wherein at least one of the first, second and third fields are in the form of a pattern.

24. The computer-readable medium of claim 23, wherein the license data structure further includes:
a fourth field identifying at least one condition that must exist prior to the at least one principal exercising the at least one right using the license.

25. The computer-readable medium of claim 24, wherein the at least one condition comprises the payment of a fee.
